(19) United States
(12) Patent Application Publication
(10) Pub. No.: US 2021/0001428 A1
(43) Pub. Date: Jan. 7, 2021

(54) IRRADIATION DEVICE, METAL SHAPING DEVICE, METAL SHAPING SYSTEM, IRRADIATION METHOD, AND METHOD FOR MANUFACTURING METAL SHAPED OBJECT

(71) Applicant: FUJIKURA LTD., Tokyo (JP)

(72) Inventors: Hiroyuki Kusaka, Sakura-shi (JP); Masahiro Kashiwagi, Sakura-shi (JP)

(73) Assignee: FUJIKURA LTD., Tokyo (JP)

(21) Appl. No.: 17/040,760

(22) PCT Filed: Mar. 28, 2019
(86) PCT No.: PCT/JP2019/013712

§ 371 Date: Sep. 23, 2020

(30) Foreign Application Priority Data
Mar. 30, 2018 (JP) 2018-069701

(51) Int. Cl. B23K 26/354; B23K 26/342; B33Y 10/00; B33Y 30/00; B33Y 50/02

(52) U.S. Cl. CPC B23K 26/354; B23K 26/342; B33Y 50/02; B33Y 30/00; B33Y 10/00

(57) ABSTRACT

The present invention causes residual stress, which may be generated in a metal shaped object (MO), to be small. A metal shaping device includes an irradiation device (13, 13A). The irradiation device (13, 13A), which is configured to irradiate a powder bed (PB) containing a metal powder with laser light (L), is able to be switched between (i) a focused state in which a beam spot diameter (D1) of laser light (L) on a surface of the powder bed (PB) has a first value and (ii) a defocused state in which the beam spot diameter (D2) of the laser light (L) on the surface of the powder bed (PB) has a second value which is larger than the first value.

### TECHNICAL FIELD

The present invention relates to an irradiation device and an irradiation method for use in metal shaping. The present invention also relates to a metal shaping device including such an irradiation device and to a metal shaping system including such a metal shaping device. The present invention also relates to a metal shaped object production method including such an irradiation method.

### BACKGROUND ART

As a method of producing a three-dimensional metal shaped object, an additive manufacturing method using a powder bed as a preform is known. Such additive manufacturing methods include (1) an electron beam mode in which, with use of an electron beam, a powder bed is (a) melted and solidified or (b) sintered and (2) a laser beam mode in which, with use of a laser beam, a powder bed is (a) melted and solidified or (b) sintered (see Non-Patent Literature 1).

According to an additive manufacturing method of the electron beam mode, auxiliary heating (also called “preheating”) for preliminary sintering of a powder bed is necessary before main heating which is performed by irradiation with an electron beam. This is because if a powder bed, which has not been subjected to preliminary sintering, is irradiated with an electron beam, then a smoking phenomenon can easily occur in which a metal powder constituting the powder bed whirls up in the form of smoke, so that it is difficult to form a normal molten pool. Note that it is known that, in auxiliary heating, a temperature of a powder bed need only be set to 0.5 times to 0.8 times (any numerical range “A to B” herein means “not less than A and not more than B”) as high as a melting point of a metal powder.

### CITATION LIST

### Non-Patent Literature

[Non-Patent Literature 1]
Chiba A., “Characteristics of Metal Structure Based on Additive Manufacturing Technique Using Electron Beam”, Measurement and Control, Vol. 54, No. 6, June 2015, p. 399-400

### SUMMARY OF INVENTION

### Technical Problem

As described above, according to an additive manufacturing method of an electron beam mode, auxiliary heating, in which a powder bed is subjected to preliminary sintering, is ordinarily performed before main heating which is performed by irradiation with an electron beam. This brings about the following disadvantage and advantage to the additive manufacturing method of the electron beam mode. The disadvantage is that it takes a long period of time for additive manufacturing of a metal shaped object, due to auxiliary heating performed before main heating. On the other hand, the advantage is that residual stress which may be generated in a completed metal shaped object is small. This is considered as a secondary effect of auxiliary heating of a powder bed.

According to an additive manufacturing method of a laser beam mode, unlike the additive manufacturing method of the electron beam mode, a charge-up of a metal powder never occurs. The smoking phenomenon described above therefore never occurs. Therefore, according to the additive manufacturing method of the laser beam mode, auxiliary heating for preliminary sintering of a powder bed is ordinarily not performed before main heating which is performed by irradiation with a laser beam. This brings about the following advantage and disadvantage to the additive manufacturing method of the laser beam mode. The advantage is that because the auxiliary heating is not performed before main heating, a period of time for additive manufacturing of a metal shaped object is short. The disadvantage, in contrast, is that a residual stress which may be generated in a completed metal shaped object is large.

Therefore, it is demanded that the disadvantage of an additive manufacturing method of a laser beam mode is reduced while the advantage thereof is maintained. Specifically, it is demanded that while a period of time for additive manufacturing of a metal shaped object is made short, residual stress, which may be generated in a completed metal shaped object, is made small.

The present invention has been made in view of the above problem, and it is an object of the present invention to provide an irradiation device, a metal shaping device, a metal shaping system, an irradiation method, or a metal shaped object production method, any of which (i) employs an additive manufacturing method of a laser beam mode and (ii) can cause residual stress, which may be generated in a completed metal shaped object, to be small while causing a period of time for additive manufacturing of the metal shaped object to be short.

### Solution to Problem

In order to attain the object, an irradiation device in accordance with an aspect of the present invention is an irradiation device for use in metal shaping, including: an irradiating section configured to irradiate, with laser light, a powder bed containing a metal powder, the irradiating section being able to be switched between (i) a focused state in which a beam spot diameter of the laser light on a surface of the powder bed has a first value and (ii) a defocused state in which the beam spot diameter of the laser light on the surface of the powder bed has a second value which is larger than the first value.

In order to attain the object, an irradiating section in accordance with an aspect of the present invention is configured to irradiate, with laser light, a powder bed containing a metal powder, the irradiating section being able to be switched between (i) a focused state in which a beam spot diameter of the laser light on a surface of the powder bed has a first value and (ii) a defocused state in which the beam spot diameter of the laser light on the surface of the powder bed has a second value which is larger than the first value.

In order to attain the object, a metal shaping device in accordance with an aspect of the present invention is a metal shaping device including: any one of the irradiation devices described above; and an optical fiber through which the laser light is to be guided.

In order to attain the object, a metal shaping system in accordance with an aspect of the present invention includes: a metal shaping device in accordance with an aspect of the present invention; a laser device configured to output the laser light; and a shaping table configured to hold the powder bed.

In order to attain the object, an irradiation method in accordance with an aspect of the present invention includes the steps of: irradiating, with laser light, a powder bed containing a metal powder, in the irradiating, switching is made between (i) a focused state in which a beam spot diameter of the laser light on a surface of the powder bed has a first value and (ii) a defocused state in which the beam spot diameter of the laser light on the surface of the powder bed has a second value which is larger than the first value.

In order to attain the object, a metal shaped object production method in accordance with an aspect of the present invention is a method of producing a metal shaped object, including the steps of: irradiating, with laser light, a powder bed containing a metal powder, in the irradiating, switching is made between (i) a focused state in which a beam spot diameter of the laser light on a surface of the powder bed has a first value and (ii) a defocused state in which the beam spot diameter of the laser light on the surface of the powder bed has a second value which is larger than the first value.

### Advantageous Effects of Invention

With an aspect of the present invention, it is possible to achieve an irradiation device, a metal shaping device, a metal shaping system, an irradiation method, or a metal shaped object production method, any of which can cause residual stress, which may be generated in a metal shaped object, to be small while employing an additive manufacturing method of a laser beam mode.

### BRIEF DESCRIPTION OF DRAWINGS

FIG. 1 is a view illustrating a configuration of a metal shaping system in accordance with an embodiment of the present invention.

FIG. 2 is a set of views (a) and (b) illustrating a configuration of an irradiation device included in the metal shaping system illustrated in FIG. 1. (a) of FIG. 2 illustrates the irradiation device in a focused state, and (b) of FIG. 2 illustrates the irradiation device in a defocused state. (c) of FIG. 2 is a plan view illustrating a beam spot of laser light emitted from the irradiation device in the focused state. (d) of FIG. 2 is a plan view illustrating a beam spot of laser light emitted from the irradiation device in the defocused state.

FIG. 3 is a set of views (a) and (b) illustrating a configuration of a variation of the irradiation device illustrated in FIG. 2.

FIG. 4 is a flowchart illustrating a flow of a metal shaped object production method in accordance with an embodiment of the present invention.

FIG. 5 is a flowchart illustrating a flow of a laser light irradiation step included in the metal shaped object production method illustrated in FIG. 4.

FIG. 6 is a set of views (a) through (e). (a) of FIG. 6 is a plan view illustrating a region which is irradiated with laser light in the laser light irradiation step illustrated in FIG. 5. (b) of FIG. 6 is a plan view showing that an irradiation point Pᵢ is irradiated with laser light in the defocused state. (c) of FIG. 6 is a plan view showing that an irradiation point Pᵢ₊₁ is irradiated with the laser light in the defocused state. (d) of FIG. 6 is a plan view showing that the irradiation point Pᵢ₊₁ is irradiated with the laser light in a focused state. (e) of FIG. 6 is a plan view showing that the irradiation point Pᵢ₊₁ is irradiated with the laser light in the defocused state.

FIG. 7 is a flowchart illustrating a flow of a variation of the laser light irradiation step illustrated in FIG. 5.

FIG. 8 is a set of views (a) through (d). (a) of FIG. 8 is a plan view illustrating a region which is irradiated with laser light in the laser light irradiation step illustrated in FIG. 7. (b) of FIG. 8 is a plan view showing that the inside of a certain region is scanned with laser light in the defocused state. (c) of FIG. 8 is a plan view showing that the inside of the certain region is scanned with laser light in the focused state. (d) of FIG. 8 is a plan view showing that the inside of a certain region is scanned with laser light in the defocused state.

### DESCRIPTION OF EMBODIMENTS

(Configuration of Metal Shaping System)

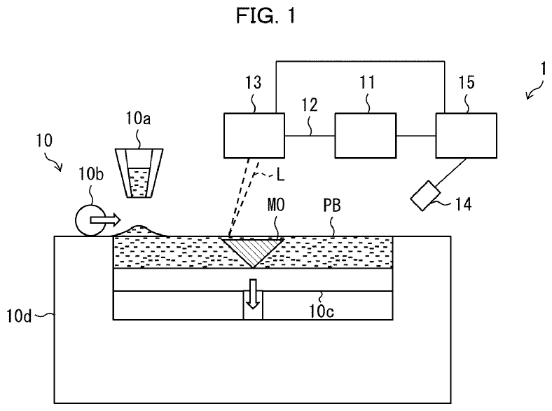

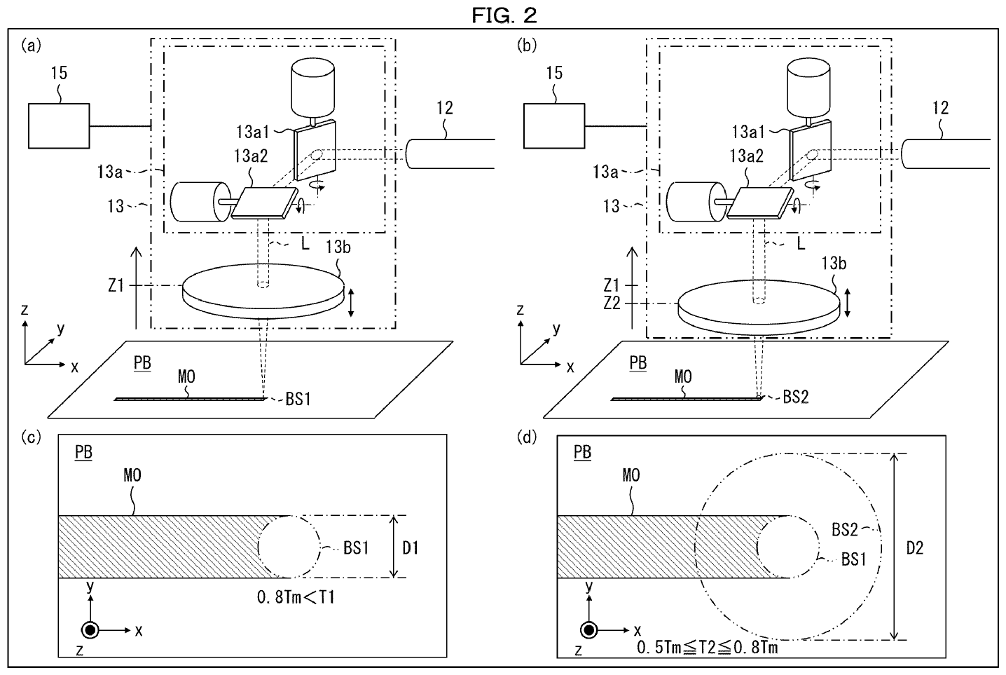

The following description will discuss, with reference to FIGS. 1 and 2, a metal shaping system 1 in accordance with an embodiment of the present invention. FIG. 1 is a view illustrating a configuration of the metal shaping system 1. (a) and (b) of FIG. 2 are a set of views illustrating a configuration of an irradiation device 13 (described later). (a) of FIG. 2 illustrates the irradiation device 13 in a focused state. (b) of FIG. 2 illustrates the irradiation device in a defocused state. (c) of FIG. 2 is a plan view illustrating beam spots BS1 and BS2 of laser light L emitted from the irradiation device 13 in the focused state. (d) of FIG. 2 is a plan view illustrating beam spots BS1 and BS2 emitted from the irradiation device 13 in the defocused state.

The metal shaping system 1 is a system for additive manufacturing of a three-dimensional metal shaped object MO. As illustrated in FIG. 1, the metal shaping system 1 includes: a shaping table 10; a laser device 11; an optical fiber 12; an irradiation device 13 including galvano scanners 13a; a measuring section 14; and a control section 15. The main parts of the metal shaping system 1 are herein called “metal shaping device”. The metal shaping device includes at least the optical fiber 12 and the irradiation device 13, and can further include the measuring section 14 and the control section 15. Note that in FIG. 1, a line connecting the control section 15 and the laser device 11 indicates a signal line for transmitting, to the laser device 11, a control signal which has been emitted from the control section 15. The control section 15 and the laser device 11 are connected to each other electrically or optically. In addition, in FIG. 1, a line connecting the control section 15 and the irradiation device 13 indicates a signal line for transmitting, to the irradiation device 13, a control signal which has been emitted from the control section 15. The control section 15 and the irradiation device 13 are connected to each other electrically or optically. Furthermore, in FIG. 1, a line connecting the control section 15 and the measuring section 14 indicates a signal line for transmitting, to the control section 15, a signal which indicates a measurement result obtained by the measuring section 14. The control section 15 and the measuring section 14 are connected to each other electrically or optically.

In the present section, the shaping table 10, the laser device 11, the optical fiber 12, and the irradiation device 13 will be described, and then effect to be brought about by this configuration will be described. The measuring section 14 and the control section 15 will be described in the next section.

The shaping table 10 is a configuration for holding a powder bed PB. As illustrated in FIG. 1, for example, the shaping table 10 can include a recoater 10a, a roller 10b, a stage 10c, and a table main body 10d on which the recoater 10a, the roller 10b, and the stage 10c are provided. The recoater 10a is a section for supplying a metal powder. The roller 10b is a section for uniformly distributing, on the stage 10c, the metal powder supplied by the recoater 10a. The stage 10c is a section on which the metal powder uniformly distributed by the roller 10b is to be placed, and is configured to be raisable and lowerable. The powder bed PB is configured to contain a metal powder which is uniformly distributed on the stage 10c. The metal shaped object MO including layers each having a certain thickness is shaped, layer by layer, by repeating the following steps (1) through (3): (1) forming a powder bed PB on the stage 10c as described earlier; (2) shaping one layer of the metal shaped object MO, as described later, by irradiating the powder bed PB with laser light L; and (3) lowering the stage 10c by an amount corresponding to one layer.

Note that the configuration of the shaping table 10 is not limited to that described earlier, provided that the shaping table 10 has a function of holding the powder bed PB. For example, it is possible that (i) the shaping table 10 includes, instead of the recoater 10a, a powder tank for containing a metal powder and (ii) the metal powder is supplied by raising a bottom plate of the powder tank.

The laser device 11 is configured to output laser light L. According to the present embodiment, the laser device 11 is a fiber laser. A fiber laser to be used as the laser device 11 can be a resonator fiber laser or a Master Oscillator-Power Amplifier (MOPA) fiber laser. In other words, the fiber laser can be a continuous wave fiber laser or a pulsed wave fiber laser. Alternatively, the laser device 11 can be a laser device other than a fiber laser. The laser device 11 can be any laser device such as a solid laser, a liquid laser, or gas laser.

The optical fiber 12 is configured to guide laser light L outputted from the laser device 11. According to the present embodiment, the optical fiber 12 is a double cladding fiber. Note, however, that the optical fiber 12 is not limited to a double cladding fiber. The optical fiber 12 can be any optical fiber such as a single cladding fiber or a triple cladding fiber.

The irradiation device 13 is configured to irradiate the powder bed PB with laser light L which is guided through the optical fiber 12. According to the present embodiment, the irradiation device 13 is a galvano-type irradiation device. The configuration of the irradiation device 13 will be described with reference to FIG. 2.

As illustrated in FIG. 2, the irradiation device 13 includes: a galvano scanner 13a including (i) a first galvano mirror 13a1 and (ii) a second galvano mirror 13a2; and a condensing lens 13b. Laser light L outputted from the optical fiber 12 is (1) reflected by the first galvano mirror 13a1, (2) reflected by the second galvano mirror 13a2, and then (3) converged by the condensing lens 13b so as to then irradiate the powder bed PB. Note that the condensing lens 13b is an example of the first condensing lens recited in the Claims.

Note that the first galvano mirror 13a1 is configured to move, in a first direction (for example, in an x-axis direction illustrated in FIG. 2), a beam spot of the laser light L which is formed on a surface of the powder bed PB. The second galvano mirror 13a2 is configured to move, in a second direction (for example, in a y-axis direction illustrated in FIG. 2) intersecting with (e.g. perpendicular to) the first direction, the beam spot of the laser light L which is formed on the surface of the powder bed PB.

The condensing lens 13b is configured to control a beam spot diameter of the laser light L on the surface of the powder bed PB. The condensing lens 13b is configured so that a position z of the condensing lens 13b can move in a third direction (e.g. the z-axis direction illustrated in FIG. 2) which intersects with (e.g. perpendicular to) both the first direction and the second direction. The irradiation device 13 in accordance with the present embodiment further includes the condensing lens 13b. This allows the irradiation device 13 to increase the power density of laser light L with which the powder bed PB is to be irradiated. Therefore, even in a case where the power of the laser light L is relatively low, it is still possible to sufficiently increase the temperature of the powder bed PB within a beam spot of the laser light L. This advantageously makes it possible to reduce electric power consumption which is required for sufficiently increasing the temperature of the powder bed PB within the beam spot of the laser light L. Similar advantageous effects can be obtained also by (i) a metal shaping device including the irradiation device 13 and (ii) a metal shaping system 1 including such a metal shaping device.

In the present embodiment, as illustrated in (a) of FIG. 2, the beam spot diameter of the beam spot of the laser light L on the surface of the powder bed PB will be described by discussing, as examples, (i) a case where the position z of the condensing lens 13b is controlled to be at z1 (i.e. z=z1) as illustrated in (a) of FIG. 2 and (ii) a case where the position z is controlled to be at z2 (i.e. z=z2) which is positioned further toward a negative side of the z-axis than z1. Hereinafter, the term “beam spot BS1” will be used for a beam spot of laser light L on the surface of the powder bed PB, which beam spot is obtained in a case where the position z is controlled to be at z1 (see (c) of FIG. 2), and the term “beam spot BS2” will be used for a beam spot of laser light L on the surface of the powder bed PB, which beam spot is obtained in a case where the position z is controlled to be at z2 (see (d) of FIG. 2).

As illustrated in (d) of FIG. 2, a beam spot diameter D2 of the beam spot BS2 is larger than a beam spot diameter D1 of the beam spot BS1. The irradiation device 13 can thus control the beam spot diameter of laser light L on the surface of the powder bed PB by moving the position z of the condensing lens 13b in z-axis directions. Specifically, by moving the position z of the condensing lens 13b, it is possible to switch between a focused state and a defocused state.

Note that the beam spots BS1 and BS2 are examples of regions of the surface of the powder bed PB, which regions are irradiated with laser light L in the Claims. Note also that the beam spot diameters D1 and D2 are examples of a first value and a second value recited in the Claims. In addition, although the description above discussed the example in which the position z is controlled to be at z1 or z2, the present invention is not limited to these positions. Specifically, provided that a beam spot diameter in the focused state is smaller than a beam spot diameter in the defocused state, it is possible to (i) set one of the beam spot diameter in the focused state and the beam spot diameter in the defocused state in advance and (ii) control the position z to have a value other than “z=z1” or “z=z2” so that the other beam spot diameter has a value different from the beam spot diameters D1 and D2.

Note that a method, by which the irradiation device 13 controls the beam spot diameter of the laser light L on the surface of the powder bed PB, is not limited to the above-described method in which the position z of the condensing lens 13b is moved. For example, the beam spot diameter of the laser light L on the surface of the powder bed PB can be controlled by moving the irradiation device 13 in the z-axis directions while the position of the condensing lens 13b relative to the galvano scanner 13a is not changed.

The power of laser light does not change even in a case where a beam spot diameter is changed. Therefore, a smaller beam spot diameter causes an energy density in the beam spot of the laser light to be higher. The beam spot diameter D2 of the beam spot BS2 illustrated in (d) of FIG. 2 is larger than the beam spot diameter D1 of the beam spot BS1 illustrated in (c) of FIG. 2. Therefore, the energy density of the beam spot BS2 is lower than the energy density of the beam spot BS1.

Hereinafter, the illustrated in (c) of FIG. 2 will be referred to as “focused state”, and the state illustrated in (d) of FIG. 2 will be referred to as “defocused state”. The beam spot diameter D1 in the focused state can be set in advance before the irradiation device 13 emits the laser light L, can be set when the irradiation device 13 emits the laser light L, or can be set after the irradiation device 13 emits the laser light L. In either case, the term “laser light L in the focused state” will be used to refer to laser light L whose beam spot diameter on the surface of the powder bed PB is a beam spot diameter D1. In contrast to the focused state in which a beam spot diameter is the beam spot diameter D1, the term “laser light L in the defocused state” will be used to refer to laser light whose beam spot diameter is the beam spot diameter D2 which is larger than the beam spot diameter D1. In addition, heating of a metal powder with use of laser light in the state illustrated in (c) of FIG. 2 will be referred to as “main heating”, and heating of a metal powder with use of laser light in the state illustrated in (d) of FIG. 2 will be referred to as “auxiliary heating”.

Increasing the energy densities of the beam spots BS1 and BS2 causes higher energy to be concentrated in one point. This causes the temperatures T1 and T2 of the beam spots BS1 and BS2 on the surface of the powder bed PB to be higher. Energy density indicates energy of laser light per unit area irradiated with the laser light. Therefore, increasing the energy density causes the amount of energy supplied per unit area to be larger. This causes the temperature of a region irradiated with the laser light to be higher. Therefore, in a case where the condition “D1<D2” is satisfied as illustrated in (c) and (d) of FIG. 2, the temperature T1 is higher than the temperature T2 of the beam spot BS2 on the surface of the powder bed PB.

In a case where it is desired that the energy density of the beam spot BS1 is the highest possible, the irradiation device 13 need only set the position z so that the beam spot diameter D1 is the smallest possible. In such a case, the beam spot diameter D1 substantially matches a beam waist diameter of laser light L converged by the condensing lens 13b.

For example, in a case where the position z is set so that the beam spot diameter D1 is the smallest possible, the energy density of the beam spot BS1 may become excessively high, depending on the power of the laser light L outputted from the laser device 11. As appropriate, the irradiation device 13 can set the position z so that the temperature T1 is a desired temperature in the focused state. In addition, the irradiation device 13 can set the position z as appropriate so that the temperature T2 in the defocused state is a desired temperature, provided that the condition “D1<D2” is satisfied. The beam spot diameters D1 and D2 can be, for example, D1=20 μm and D2=200 μm. In such a case, the beam spot diameter D2 is 10 times as large as the beam spot diameter D1.

The irradiation device 13 thus configured can switch between (i) the focused state in which the beam spot diameter D1 of the laser light L is so small as to be suitable for main heating, that is, the focused state in which the energy density is high and (ii) the defocused state in which the beam spot diameter D2 of the laser light L is so large as to be suitable for auxiliary heating, that is, the defocused state in which the energy density is low. In other words, the irradiation device 13 can switch between a state suitable for main heating and a state suitable for auxiliary heating. By using the main heating and the auxiliary heating in combination while switching between them, it is possible to decrease a temperature difference between (i) a region which has been subjected to the main heating and (ii) a region around such a region. As a result, it is possible to slow down a decrease in temperature of at least part of the layers of a metal shaped object MO which has been solidified or sintered after the main heating ended. Therefore, with the metal shaping system 1 which includes the irradiation device 13, residual stress in the metal shaped object MO can be made small (e.g. approximately identical to residual stress in a metal shaping device for which an electron beam is used).

As described above, the irradiation device 13 can switch between the main heating and the auxiliary heating with use of a single laser device. The irradiation device 13 can therefore perform the main heating and the auxiliary heating with use of a simple configuration without individually using respective laser devices for the main heating and for the auxiliary heating. According to the present embodiment, in particular, the focused state and the defocused state can be achieved by a single galvano scanner 13a. This makes it possible to perform the heating without having a large interval (in terms of time and/or space) between the states. It is therefore unnecessary to take excess time for the auxiliary heating, and unnecessary to provide excess equipment for performing the auxiliary heating.

The irradiation device 13 preferably controls the position z so that (1) the temperature T1 on the surface of the powder bed PB is not less than the melting point Tm of the metal powder in the focused state and (2) the temperature T2 on the surface of the powder bed PB is 0.5 times to 0.8 times as high as the melting point Tm in the defocused state.

Furthermore, the irradiation device 13 can control the position z so that the temperature T1 on the surface of the powder bed PB is higher than the 0.8 times as high as the melting point Tm and lower than the melting point Tm in the focused state.

In a case where the position z is controlled so that the temperature T1 is caused by the main heating to be not less than the melting point Tm, the powder bed PB becomes melted and solidified in the track of the beam spot BS1. This shapes each layer of the metal shaped object MO. Meanwhile, in a case where the position z is controlled so that the temperature T1 is caused by the main heating to be higher than 0.8 times as high as the melting point Tm and lower than the melting point Tm, the powder bed PB becomes sintered in the track of the beam spot BS1. This shapes each layer of the metal shaped object MO. In addition, by the above configuration, the temperature T2 before or after the irradiation with the laser light L for the main heating can be raised by the auxiliary heating. This makes it possible to decrease a difference between (i) the temperature T1 of the beam spot BS1 and (ii) a temperature of a region in the vicinity of the beam spot BS1. It is therefore possible to more reliably decrease residual stress in a metal shaped object MO, with each of the following: the irradiation device 13, a metal shaping device including the irradiation device 13, and the metal shaping system 1.

Note that the position z can be controlled by the control section 15 (described later). That is, the metal shaping device and the metal shaping system 1, each of which includes the irradiation device 13, are preferably each configured to further include the control section 15 which controls the position z so that, while the irradiation device 13 is in the defocused state, the temperature of the beam spot BS2 on the surface of the powder bed PB is 0.5 times to 0.8 times as high as the melting point Tm.

There is a possibility that the temperature T2 fluctuates even in a case where the surface of the powder bed PB is irradiated during the auxiliary heating with laser light L having constant power. If the metal shaping device and the metal shaping system 1 each include the control section 15 described later, the temperature T2 can be maintained at a suitable temperature even in a case where the temperature T2 fluctuates during the auxiliary heating for any reason. This allows the metal shaping device and the metal shaping system 1 to each cause residual stress in a metal shaped object to be smaller even in a case where the temperature T2 may fluctuate.

Note that it is preferable that when the irradiation device 13 is in the focused state, the control section 15 controls the position z of the condensing lens 13b so that the temperature T1 on the surface of the powder bed PB is higher than 0.8 times as high as the melting point Tm or not less than the melting point Tm.

In a case where the temperature T1 of the beam spot BS1 during the main heating is higher than 0.8 times as high as the melting point Tm and is lower than the melting point Tm, the metal powder on the surface of the powder bed PB has certain strength by being sintered, although not melted. Therefore, with the metal shaping system 1, it is possible to obtain a metal shaped object MO including a metal powder which has been sintered.

(Variations of Irradiation Device)

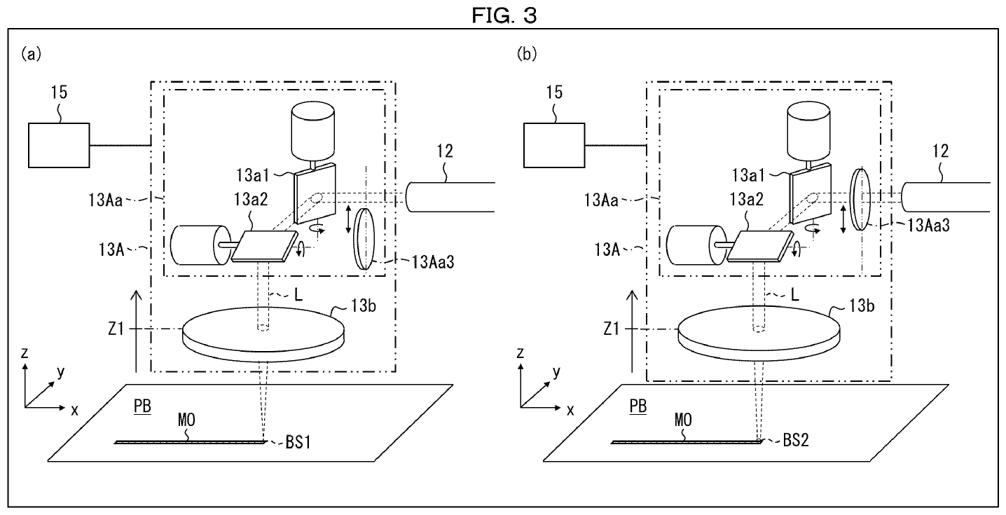

An irradiation device 13A, which is a variation of the irradiation device 13 illustrated in (a) and (b) of FIG. 2, will be described with reference to (a) and (b) of FIG. 3. (a) and (b) of FIG. 3 are a set of views illustrating a configuration of the irradiation device 13A. (a) of FIG. 3 illustrates the irradiation device 13A in a focused state. (b) of FIG. 3 illustrates the irradiation device 13A in a defocused state.

As with the irradiation device 13, the irradiation device 13A includes: a galvano scanner 13Aa including (i) a first galvano mirror 13a1 and (ii) a second galvano mirror 13a2; and a condensing lens 13b (see (a) and (b) of FIG. 3). The galvano scanner 13Aa included in the irradiation device 13A further includes a condensing lens 13Aa3. The first galvano mirror 13a1, the second galvano mirror 13a2, and the condensing lens 13b are configured as with the irradiation device 13, and will therefore not be described. The present variation will discuss the condensing lens 13Aa3 which is an example of the second condensing lens recited in the Claims.

In addition to the condensing lens 13b, the condensing lens 13Aa3 is configured to control a beam spot diameter of laser light L on a surface of a powder bed PB. According to the present variation, the condensing lens 13Aa3 is provided between the optical fiber 12 and the first galvano mirror 13a1, and is configured so that a position z of the condensing lens 13Aa3 can move in a third direction (e.g. the z-axis direction illustrated in FIG. 3).

The irradiation device 13A can therefore insert and remove the condensing lens 13Aa3 into/from an optical path of the laser light L. In other words, with the metal shaping device and the metal shaping system 1, the control section 15 can control the position of the condensing lens 13Aa3 so as to insert and remove the condensing lens 13Aa3 into/from the optical path of the laser light L. Note that the control section 15 can be configured to move the condensing lens 13b while the condensing lens 13Aa3 and the condensing lens 13b are both provided. In such a case, the control section 15 can be configured to move the condensing lens 13b in, for example, the x-axis directions and/or y-axis directions so as to insert and remove the condensing lens 13b into/from the optical path of the laser light L.

According to the present embodiment, the condensing lens 13Aa3 is moved in the z-axis directions so as to be removed from the optical path. However, a direction, in which the condensing lens 13Aa3 is to be removed so as to be moved from the optical path, can be any direction, provided that the condensing lens 13Aa3 can be removed from the optical path of the laser light L. For example, the condensing lens 13Aa3 can be moved in the y-axis directions to accomplish such a purpose.

In addition, the position in the optical path of the laser light L, at which the condensing lens 13Aa3 is to be provided, is not limited to a position between the optical fiber 12 and the first galvano mirror 13a1. The condensing lens 13Aa3 can be provided at any position in the optical path of the laser light L, provided that there is a space in which the condensing lens 13Aa3 can be provided. In regard to a positional relationship between the condensing lens 13b and the condensing lens 13Aa3, the condensing lens 13b can be positioned further downstream than the condensing lens 13Aa3 (see FIG. 3), or the condensing lens 13b can be positioned further upstream than the condensing lens 13Aa3, where (i) a side closer to the optical fiber 12 is the upstream side of the optical path and (ii) a side closer to the powder bed PB is the downstream side of the optical path.

In order to be in the focused state, the irradiation device 13A controls the position z of the condensing lens 13b to be at z1 (i.e. z=z1) while the condensing lens 13Aa3 is removed from the optical path (see (a) of FIG. 3). The beam spot diameter D1 of the laser light L in this case is identical to that in the state illustrated in (c) of FIG. 2.

In order to be in the defocused state, the irradiation device 13A inserts the condensing lens 13Aa3 into the optical path without changing the position z from z1 (i.e. z=z1) (see (b) of FIG. 3). Note that the condensing lens 13Aa3 is provided in the irradiation device 13A in such a manner as to be able to be inserted into and removed from the optical path of the laser light L. This causes a divergence angle of the optical path of the laser light L to be different in comparison with the state in which the condensing lens 13Aa3 is not inserted into the optical path. As a result, as with the case where the position z is changed to z2 (i.e. z=z2), the beam spot diameter D2 can be larger than the beam spot diameter D1. The beam spot diameter D2 of the laser light L in this case is identical to that in the state as illustrated in (d) of FIG. 2. Therefore, by inserting and removing the condensing lens 13Aa3 into/from the optical path of the laser light L, it is possible to switch between the focused state and the defocused state.

According to the present embodiment, the irradiation device 13A has a configuration (1) in which the irradiation device 13A is (i) in the focused state while the condensing lens 13Aa3 is removed from the optical path of the laser light L and (ii) in the defocused state while the condensing lens 13Aa3 is inserted into the optical path of the laser light L. However, the irradiation device 13A can have a configuration (2) in which the irradiation device 13A is (i) in the defocused state while the condensing lens 13Aa3 is removed from the optical path of the laser light L and (ii) in the focused state while the condensing lens 13Aa3 is inserted into the optical path of the laser light L. Note that the configuration (1) is preferable to the configuration (2), in order to increase the accuracy of the beam spot BS1 in the focused state. This is because the configuration (1) makes it unnecessary to provide a moving mechanism for accurately and quickly inserting and removing the lens, and can therefore be achieved with a relatively simple configuration.

As with the irradiation device 13, the irradiation device 13A can set the position z as appropriate so that the temperature T1 is a desired temperature T in the focused state. In addition, the irradiation device 13A can set a focal length of the condensing lens 13Aa3 as appropriate so that the temperature T2 is a desired temperature in the defocused state, provided that the condition “D1<D2” is satisfied.

The irradiation device 13A thus configured brings about effects similar to those of the irradiation device 13.

(Measuring Section and Control Section)

As described earlier, the metal shaping device can include the measuring section 14 and the control section 15. The measuring section 14 and the control section 15 will be described in the present section.

The measuring section 14 is configured to measure a temperature T (for example, surface temperature) of the powder bed PB. The measuring section 14 is, for example, a thermal camera. The control section 15 is configured to control the irradiation device 13 or the irradiation device 13A. The present embodiment will discuss the irradiation device 13 as an example. The control section 15 is, for example, a microcomputer. According to the present embodiment, the control section 15 controls the irradiation device 13 on the basis of the temperature T measured by the measuring section 14.

For example, in a case of the irradiation device 13 illustrated in FIG. 2, the control section 15 controls the position z of the condensing lens 13b so as to switch between the focused state (illustrated in (a) of FIG. 2) and the defocused state (illustrated in (b) of FIG. 2). In the case of the irradiation device 13A illustrated in FIG. 3, the control section 15 performs control to insert or remove the condensing lens 13Aa3 into/from the optical path of the laser light L so as to switch between the focused state (illustrated in (a) of FIG. 3) and the defocused state (illustrated in (b) of FIG. 3).

An example of the process carried out by the control section 15 will be described below. In a case (1) where the irradiation device 13 is in the focused state, the control section 15 controls the position z of the condensing lens 13b so that the temperature T1 on the surface of the powder bed PB is not less than the melting point Tm. In a case (2) where the irradiation device 13 is in the defocused state, the control section 15 controls the position z of the condensing lens 13b so that the temperature T2 on the surface of the powder bed PB is 0.5 times to 0.8 times as high as the melting point Tm. With this configuration, the metal shaping device and the metal shaping system 1 can shape each layer of a metal shaped object MO by melting and solidifying a metal powder. In addition, as described above, residual stress in the metal shaped object MO can be made small.

In a case where each layer of the metal shaped object MO is to be shaped by sintering the metal powder, the control section 15 can perform control as follows. That is, in a case where (1) the irradiation device 13 is in the focused state, the control section 15 controls the position z of the condensing lens 13b so that the temperature T1 on the surface of the powder bed PB is higher than 0.8 times as high as the melting point Tm and lower than the melting point Tm. In a case (2) where the irradiation device 13 is in the defocused state, the control section 15 controls the position z of the condensing lens 13b so that the temperature T2 on the surface of the powder bed PB is 0.5 times to 0.8 times as high as the melting point Tm. In this case also, the metal shaping device and the metal shaping system 1 can cause residual stress in the metal shaped object MO to be small.

Furthermore, the control section 15 can control the position z so that transition is made from the focused state to the defocused state or from the defocused state to the focused state, while the position of an irradiation point, at which the surface of the powder bed PB is irradiated with laser light L, is maintained.

Alternatively, the control section 15 can control the position z so that transition is made from the defocused state to the focused state and then transition is made from the focused state to the defocused state, while the position of the irradiation point, at which the surface of the powder bed PB is irradiated with the laser light L, is maintained.

Alternatively, the control section 15 can control the irradiation device 13 to perform at least the following steps (1), (2), and (3) in this order: (1) the position, at which the surface of the powder bed PB is irradiated with the laser light L, is moved (i.e. scanning is performed) while one of the focused state and the defocused state is maintained, (2) transition is made from the above one of the focused state and the defocused state to the other one, and (3) the position, at which the surface of the powder bed PB is irradiated with the laser light L, is moved (i.e. scanning is performed) while the other one of the focused state and the defocused state is maintained.

Alternatively, the control section 15 can control the irradiation device 13 to perform at least the following steps (1), (2), (3), (4), and (5) in this order: (1) the position, at which the surface of the powder bed PB is irradiated with the laser light L, is moved (i.e. scanning is performed) while the defocused state is maintained, (2) transition is made from the defocused state to the focused state, (3) the position, at which the surface of the powder bed PB is irradiated with the laser light L, is moved (i.e. scanning is performed) while the focused state is maintained, (4) transition is made from the focused state to the defocused state, and (5) the position, at which the surface of the powder bed PB is irradiated with the laser light L, is moved (i.e. scanning is performed) while the defocused state is maintained.

These steps described above and effects obtained by these steps will be discussed in the next section.

(Method of Producing Metal Shaped Object)

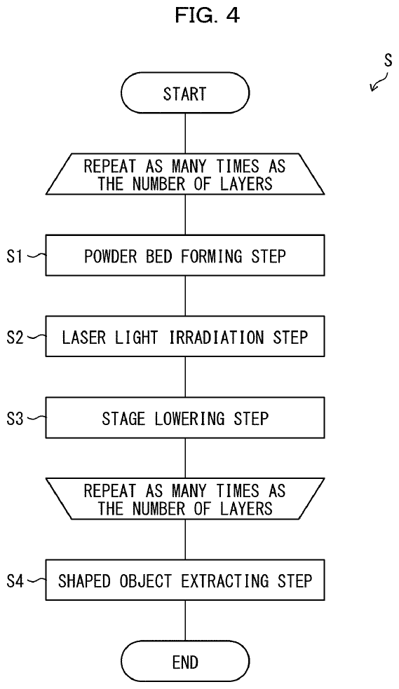

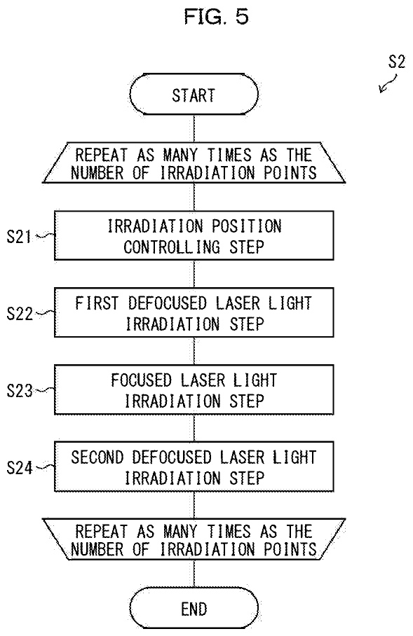

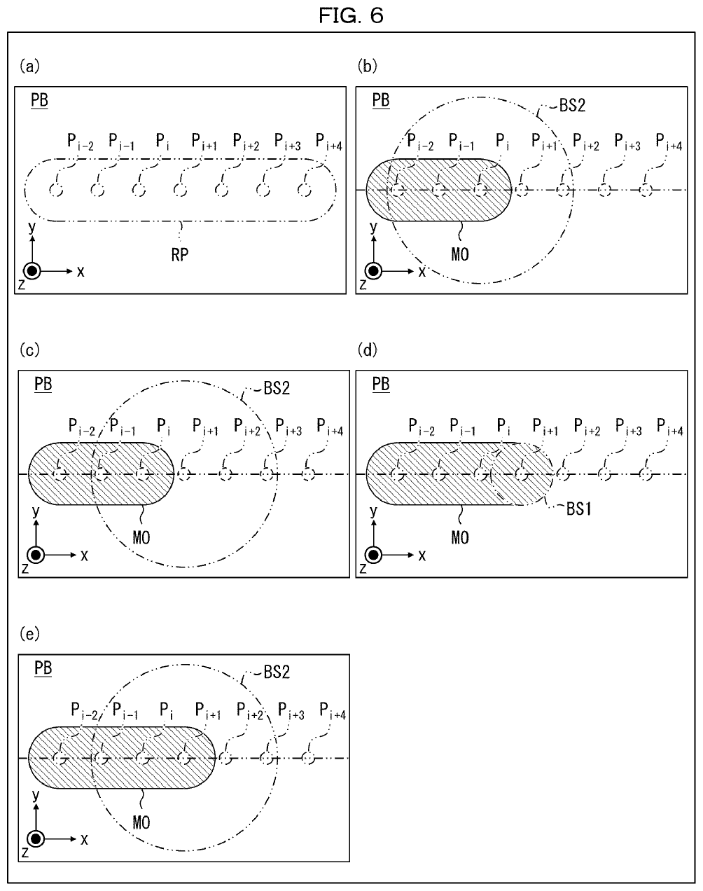

A production method S of producing a metal shaped object MO with use of the metal shaping system 1 will be described with reference to FIGS. 4 through 6. FIG. 4 is a flowchart illustrating a flow of the production method S. FIG. 5 is a flowchart illustrating a flow of a laser light irradiation step S2 included in a production method S. (a) of FIG. 6 is a plan view illustrating a region RP which is irradiated with laser light L in the laser light irradiation step S2. (b) of FIG. 6 is a plan view showing that an irradiation point Pᵢ is irradiated with laser light L in a defocused state. (c) of FIG. 6 is a plan view showing that an irradiation point Pᵢ₊₁ is irradiated with the laser light L in the defocused state. (d) of FIG. 6 is a plan view showing that the irradiation point Pᵢ₊₁ is irradiated with the laser light L in a focused state. (e) of FIG. 6 is a plan view showing that the irradiation point Pᵢ₊₁ is irradiated with the laser light L in the defocused state.

As illustrated in FIG. 4, the production method S includes a powder bed forming step S1, a laser light irradiation step S2 (an example of the “irradiation method” recited in the Claims), a stage lowering step S3, and a shaped object extracting step S4. As described earlier, the metal shaped object MO is shaped, layer by layer. The powder bed forming step S1, the laser light irradiation step S2, and the stage lowering step S3 are repeated as many times as the number of layers. The metal shaped object MO is thus completed by repeating the powder bed forming step S1, the laser light irradiation step S2, and the stage lowering step S3 as many times as the number of layers.

The powder bed forming step S1 is the step of forming a powder bed PB on the stage 10c of the shaping table 10. The powder bed forming step S1 can be achieved by, for example, (1) the step of supplying a metal powder with use of the recoater 10a and (2) the step of uniformly distributing the metal powder on the stage 10c with use of the roller 10b.

The laser light irradiation step S2 is the step of shaping one layer of the metal shaped object MO by irradiating the powder bed PB with the laser light L. Note also that a region RP irradiated with the laser light L in the laser light irradiation step S2 is at least part of the whole region of the powder bed PB, and is determined in accordance with the shape of a layer of the metal shaped object MO. The laser light irradiation step S2 will be described in detail in the section after the section describing the shaped object extracting step S4.

The stage lowering step S3 is the step of lowering the stage 10c of the shaping table 10 by as much an amount as one layer. This allows a new powder bed PB to be formed on the stage 10c.

The shaped object extracting step S4 is the step of extracting a completed metal shaped object MO from the powder bed PB. The metal shaped object MO is produced in this way.

(Laser Light Irradiation Step S2)

The present embodiment will discuss the laser light irradiation step S2 by discussing, as an example, a case where the region RP having a linear shape is irradiated with the laser light L as illustrated in (a) of FIG. 6. Note that the following description will discuss the laser light irradiation step S2 by using an example in which the metal shaped object MO is shaped by melting and solidifying a metal powder. However, it is possible to carry out the laser light irradiation step S2 so as to shape a metal shaped object MO by sintering a metal powder.

In the laser light irradiation step S2, the control section 15 can control the irradiation device 13 so that transition is made from the focused state to the defocused state or from the defocused state to the focused state, while the position of an irradiation point, at which the surface of the powder bed PB is irradiated with laser light L, is maintained. Specifically, the control section 15 can (1) transition the irradiation device 13 from the focused state to the defocused state while the position of the irradiation point irradiated with the laser light L is maintained or (2) transition the irradiation device 13 from the defocused state to the focused state while the position of the irradiation point irradiated with the laser light L is maintained.

With this configuration, it is possible to perform auxiliary heating in the defocused state immediately before or immediately after main heating in the focused state. Therefore, a metal shaped object MO, in which residual stress is made further smaller, can be obtained by, in the laser light irradiation step S2, controlling the irradiation device 13 so that transition is made from the focused state to the defocused state or from the defocused state to the focused state, while the position of an irradiation point, at which the surface of the powder bed PB is irradiated with laser light L, is maintained. In addition, the metal shaping system 1 including such a control section 15 can cause residual stress in a completed metal shaped object to be further smaller.

In addition, in the laser light irradiation step S2, the control section 15 preferably causes the irradiation device 13 to be transitioned from the defocused state to the focused state and then transitioned made from the focused state to the defocused state, while the position of the irradiation point, at which the surface of the powder bed PB is irradiated with the laser light L, is maintained.

With this configuration, it is possible to perform auxiliary heating in the defocused state immediately before and immediately after main heating in the focused state. Therefore, a metal shaped object, in which residual stress is even further smaller, can be obtained by, in the laser light irradiation step S2, causing the irradiation device 13 to be transitioned from the defocused state to the focused state and then transitioned from the focused state to the defocused state, while the position of the irradiation point, at which the surface of the powder bed PB is irradiated with the laser light L, is maintained. In addition, the metal shaping system 1 including such a control section 15 can cause residual stress in a completed metal shaped object to be even further smaller.

Such a laser light irradiation step S2 will be described below by using a concrete example.

When the control section 15 has obtained, from an outside source, information concerning a region RP to be irradiated with laser light, the control section 15 determines a plurality of irradiation points to be irradiated with the laser light L in the region RP. In the example of (a) of FIG. 6, the region RP has the linear shape. The control section 15 therefore determines irradiation points Pᵢ (where i is an integer of 1 to N, and N is any integer) which are arranged linearly. In the example of (a) of FIG. 6, the irradiation points Pᵢ₋₂ through Pᵢ₊₄ of the irradiation points Pᵢ are illustrated. According to the present embodiment, the control section 15 obtains the information concerning the region RP from an outside source. However, the region RP can be a region that is determined in advance. In addition, according to the present embodiment, the control section 15 determines the plurality of irradiation points included in the region RP. However, if the region RP is determined in advance, the positions of the plurality of irradiation points can also be determined in advance.

Intervals between adjacent irradiation points Pᵢ (e.g. a distance between centers of Pᵢ and Pᵢ₊₁) can be set as appropriate according to the beam spot diameter D1. Setting narrow intervals between the irradiation points Pᵢ allows the plurality of irradiation points (in other words, points at which the metal powder melts) to be provided with high density. This makes it possible to obtain a metal shaped object MO with high quality (i.e. having smooth surfaces). Meanwhile, setting wide intervals between the irradiation points Pᵢ allows the number of plurality of irradiation points to be small. This makes it possible to obtain a metal shaped object MO in a short period of time. The interval between the irradiation points Pᵢ can be adjusted as appropriate depending on which of the following is prioritized: the quality of a metal shaped object MO; or a period of time it takes to shape the metal shaped object MO.

For example, in the state illustrated in (d) of FIG. 6, the intervals between the irradiation points Pᵢ are each set to be ⅔ of the beam spot diameter D1. Another example of the intervals between the irradiation points Pᵢ is ⅓ of the beam spot diameter D1. In a case where it is desired to reduce the period of time required for shaping the metal shaped object MO, the intervals between the irradiation points Pᵢ are preferably each set to be approximately identical to the beam spot diameter D1. Setting the intervals between the irradiation points Pᵢ each to be approximately identical to the beam spot diameter D1 makes it possible to lower the number of the irradiation points Pᵢ. This allows for a reduction in the period of time required for shaping the metal shaped object MO. Then, focusing on each of the adjacent irradiation points Pᵢ shows that the beam spots BS1 may be in contact with each other at respective circumferences. This advantageously allows the inside of the region RP to be reliably subjected to the main heating. In addition, focusing on each of the adjacent irradiation points Pᵢ also shows that the beam spots BS1 are unlikely to overlap each other. This advantageously makes the occurrence of uneven temperatures to be unlikely.

As illustrated in FIG. 5, the laser light irradiation step S2 includes an irradiation position controlling step S21, a first defocused laser light irradiation step S22, a focused laser light irradiation step S23, and a second defocused laser light irradiation step S24. The irradiation position controlling step S21, the first defocused laser light irradiation step S22, the focused laser light irradiation step S23, and the second defocused laser light irradiation step S24 are repetitive steps to be repeated as many times as the number of irradiation points. The present embodiment will discuss the laser light irradiation step S2 by taking, as an example, the irradiation position controlling step S21, the first defocused laser light irradiation step S22, the focused laser light irradiation step S23, and the second defocused laser light irradiation step S24 which are carried out with respect to the irradiation point Pᵢ₊₁ of the irradiation points Pᵢ₋₂ through Pᵢ₊₄ illustrated in (a) of FIG. 6. Specifically, the following description will start discussing the steps included in the repetitive steps from a state in which (i) a metal shaped object MO is formed in the vicinity of the irradiation points Pᵢ₋₂ through Pᵢ of the irradiation points Pᵢ₋₂ through Pᵢ₊₄ illustrated in (a) of FIG. 6 and (ii) the irradiation point Pᵢ is irradiated with laser light L whose beam spot diameter is the beam spot diameter D2 (see (b) of FIG. 6).

The irradiation position controlling step S21 is a step of moving the position of the irradiation point irradiated with the laser light L, from an irradiation point (A) to an irradiation point (B) among the irradiation points Pᵢ₋₂ through Pᵢ₊₄ set as illustrated in (a) of FIG. 6, the irradiation point (A) being an irradiation point which has been subjected to the repetitive steps (i.e. the irradiation point Pᵢ in the present embodiment) and the irradiation point (B) being an irradiation point which will be subjected to the repetitive steps next (i.e. the irradiation point Pᵢ₊₁ in the present embodiment).

(b) of FIG. 6 shows that the irradiation point Pᵢ is irradiated with the laser light L in the defocused state. That is, (b) of FIG. 6 shows a state after the second defocused laser light irradiation step S24 has been carried out. In the irradiation position controlling step S21, the position of the irradiation point irradiated with the laser light L is moved from the irradiation point Pᵢ to the irradiation point Pᵢ₊₁ (which is an irradiation point by which the irradiation point Pᵢ is followed) while the defocused state is maintained on the surface of the powder bed PB. In a case where the irradiation position controlling step S21 is carried out, the laser light L, with which the surface of the powder bed PB is irradiated, is transitioned from the state illustrated in (b) of FIG. 6 to the state illustrated in (c) of FIG. 6.

Note that in a case where the irradiation position controlling step S21 is carried with respect to an irradiation point Pᵢ which is a second irradiation point P₂ or a subsequent irradiation point, the irradiation position controlling step S21 is carried out after the second defocused laser light irradiation step S24 has been carried out with respect to the irradiation point Pᵢ₋₁ which precedes the irradiation point Pᵢ. Therefore, the irradiation device 13 is in the defocused state. In this case, the laser light irradiation step S2 preferably excludes the step of transitioning the state of the irradiation device 13 again before the irradiation position controlling step S21 is carried out with respect to the irradiation point Pᵢ.

In a case where the irradiation position controlling step S21 is carried out with respect to the first irradiation point P₁, one of the following states of the irradiation device 13 is possible: (1) the defocused state, (2) the focused state, and (3) the state in which the laser light L is not emitted. In the case of the state (1), the laser light irradiation step S2 preferably excludes the step of transitioning the state of the irradiation device 13 again before the irradiation position controlling step S21 is carried out with respect to the irradiation point Pᵢ. In the case of the state (2) or (3), the laser light irradiation step S2 preferably includes, before the irradiation position controlling step S21 is carried out with respect to the irradiation point Pᵢ, the step of transitioning the irradiation device 13 from (i) the focused state or a state which is neither the defocused state nor the focused state to (ii) the defocused state.

The first defocused laser light irradiation step S22 is the step of irradiating the surface of the powder bed PB with the laser light L emitted from the irradiation device 13 so that the beam spot on the surface of the powder bed PB is the beam spot BS2. The first defocused laser light irradiation step S22 is an aspect of the step of performing the auxiliary heating. While the first defocused laser light irradiation step S22 is being carried out, the laser light L, with which the surface of the powder bed PB is irradiated, remains in the state illustrated in (c) of FIG. 6.

The focused laser light irradiation step S23 is the step of causing the irradiation device 13 to be transitioned from the defocused state to the focused state while the position of the irradiation point, at which the surface of the powder bed PB is irradiated with the laser light L, is maintained so as to irradiate the surface of the powder bed PB with the laser light L emitted from the irradiation device 13 so that the beam spot on the surface of the powder bed PB is the beam spot BS1. The focused laser light irradiation step S23 is an aspect of the step of performing the main heating. As illustrated in (d) of FIG. 6, carrying out the focused laser light irradiation step S23 causes the metal powder to be melted and then solidified in the vicinity of the irradiation point Pᵢ₊₁. In a case where the focused laser light irradiation step S23 is carried out, the laser light L, with which the surface of the powder bed PB is irradiated, is transitioned from the state illustrated in (c) of FIG. 6 to the state illustrated in (d) of FIG. 6.

The second defocused laser light irradiation step S24 is the step of causing the irradiation device 13 to be transitioned from the focused state to the defocused state while the position of the irradiation point, at which the surface of the powder bed PB is irradiated with the laser light L, is maintained so as to irradiate the surface of the powder bed PB with the laser light L emitted from the irradiation device 13 so that the beam spot on the surface of the powder bed PB is the beam spot BS2. The second defocused laser light irradiation step S24 is an aspect of the step of performing the auxiliary heating. In a case where the second defocused laser light irradiation step S24 is carried out, the shape of the beam spot of the laser light on the surface of the powder bed PB is transitioned from the state illustrated in (d) of FIG. 6 to the state illustrated in (e) of FIG. 6.

By carrying out the second defocused laser light irradiation step S24 in the laser light irradiation step S2 as described above, it is possible to perform the auxiliary heating immediately after the main heating is performed. Therefore, in comparison with a case where the second defocused laser light irradiation step S24 is excluded, the speed of a decrease in temperature of the metal powder after the main heating can be slowed down. This allows residual stress in a completed metal shaped object MO to be small. Note that performing the auxiliary heating after the main heating may bring the advantage of causing the residual stress in the metal shaped object MO to be further smaller. This is because performing the auxiliary heating makes it possible to not only reduce a temperature difference between the region subjected to the main heating and a region around such a region, but also slow down a decrease in temperature of at least part of the layers of a metal shaped object MO which is solidified or sintered after the main heating has ended.

In addition, by carrying out the first defocused laser light irradiation step S22 in the laser light irradiation step S2, it is possible to perform the auxiliary heating immediately before the main heating is performed. That is, it is possible to heat the metal powder on the surface of the powder bed PB. Therefore, in comparison with the case where the first defocused laser light irradiation step S22 is excluded, it is possible to raise the temperature of the metal powder in advance before the focused laser light irradiation step S23 is carried out, so that it is possible to reduce a difference between the temperature T1 of the beam spot BS1 and the temperature of the region in the vicinity of the beam spot BS1. This makes it possible to cause residual stress in a completed metal shaped object MO to be further smaller.

Furthermore, carrying out the first defocused laser light irradiation step S22 before the focused laser light irradiation step S23 can bring secondary advantages below.

The first secondary advantage is that lamination density of the metal shaped object MO is unlikely to decrease. If the first defocused laser light irradiation step S22 is omitted, the powder bed PB is rapidly heated when the focused laser light irradiation step S23 is carried out. This causes a metal liquid, which is generated as a result of melting of the metal powder, to easily have large momentum, so that flatness of surfaces of a metal solid generated as a result of solidifying of the metal liquid is easily impaired. This causes the lamination density of the metal shaped object MO to easily decrease. In contrast, in a case where the first defocused laser light irradiation step S22 is carried out, it is possible to slow down an increase in temperature of the powder bed PB which occurs when the focused laser light irradiation step S23 is carried out. This causes a metal liquid, which is generated as a result of melting of the metal powder, to be unlikely to have large momentum, so that flatness of surfaces of a metal solid generated as a result of solidifying of the metal liquid is unlikely to be impaired. This causes the lamination density of the metal shaped object MO to be unlikely to decrease.

The second secondary advantage is that it is possible to cause the power of laser light, which is emitted during the focused laser light irradiation step S23, to be small. This is because having carried out the first defocused laser light irradiation step S22 has already caused the temperature of the powder bed PB to be somewhat high.

The third secondary advantage is that variation, which occurs in temperatures of parts of the powder bed PB when the focused laser light irradiation step S23 is carried out, can be made small. For example, assume a case where the temperature of the powder bed PB is raised from 20° C. to 1000° C. by carrying out the focused laser light irradiation step S23 without carrying out the first defocused laser light irradiation step S22. In such a case, the temperature is raised by approximately 1000° C. by carrying out the focused laser light irradiation step S23. Therefore, if the variation in temperature rise falls within ±10%, the temperature of the powder bed PB when the focused laser light irradiation step S23 is carried out varies within a range of approximately 900° C. to 1100° C. If the variation in temperature of the powder bed PB when the focused laser light irradiation step S23 is carried out is thus large, unfortunately excessive heating and insufficient heating can easily occur at one portion and another portion, respectively.

In contrast, assume a case where the temperature of the powder bed PB is raise to 600° C. by carrying out the first defocused laser light irradiation step S22 and then raised from 600° C. to 1000° C. by carrying out the focused laser light irradiation step S23. In such a case, the temperature is raised by approximately 400° C. by carrying out the focused laser light irradiation step S23. Therefore, if the variation in temperature rise falls within ±10%, the temperature of the powder bed PB when the focused laser light irradiation step S23 is carried out varies within a range of approximately 960° C. to 1040° C. If the variation in temperature of the powder bed PB when the focused laser light irradiation step S23 is carried out is thus small, excessive heating and insufficient heating are unlikely to occur at one portion and another portion, respectively.

Note that the laser light irradiation step S2 in accordance with the present embodiment includes the first defocused laser light irradiation step S22, the focused laser light irradiation step S23, and the second defocused laser light irradiation step S24. However, the laser light irradiation step S2 can exclude any one of the first defocused laser light irradiation step S22 and the second defocused laser light irradiation step S24.

Assume case where the first defocused laser light irradiation step S22 is excluded from the laser light irradiation step S2. In this case, after the second defocused laser light irradiation step S24 is carried out with respect to the irradiation point Pᵢ, the irradiation position controlling step S21 is carried out so as to move the irradiation position of the laser light L on the surface of the powder bed PB from the irradiation point Pᵢ to the irradiation point Pᵢ₊₁ (which is an irradiation point by which the irradiation point Pᵢ is followed) while the state of the irradiation device 13 is being transitioned from the defocused state to the focused state. As a result, the state illustrated in (c) of FIG. 6 is skipped, and transition is made to the state illustrated in (d) of FIG. 6. In the focused laser light irradiation step S23, the surface of the powder bed PB is irradiated with the laser light L emitted from the irradiation device 13 while the position of the irradiation point, at which the surface of the powder bed PB is irradiated with the laser light L, is maintained so that the beam spot on the surface of the powder bed PB is the beam spot BS1.

Assume a case where the second defocused laser light irradiation step S24 is excluded from the laser light irradiation step S2. In this case, after the focused laser light irradiation step S23 is carried out with respect to the irradiation point Pᵢ, the irradiation position controlling step S21 is carried out so as to move the position of the irradiation point irradiated with the laser light L on the surface of the powder bed PB from the irradiation point Pᵢ to the irradiation point Pᵢ₊₁ (which is an irradiation point by which the irradiation point Pᵢ is followed) while the state of the irradiation device 13 is being transitioned from the focused state to the defocused state. As a result, while the state illustrated in (a) of FIG. 6 is skipped, transition is made from (i) a state in which the powder bed PB is irradiate with the laser light L so that a beam spot in the vicinity of the irradiation point Pᵢ is the beam spot BS1 (this state is not illustrated in FIG. 6) to (ii) the state illustrated in (c) of FIG. 6. In the first defocused laser light irradiation step S22, the surface of the powder bed PB is irradiated with the laser light L emitted from the irradiation device 13 while the position of the irradiation point, at which the surface of the powder bed PB is irradiated with the laser light L, is maintained so that the beam spot on the surface of the powder bed PB is the beam spot BS2.

(Variation of Laser Light Irradiation Step)

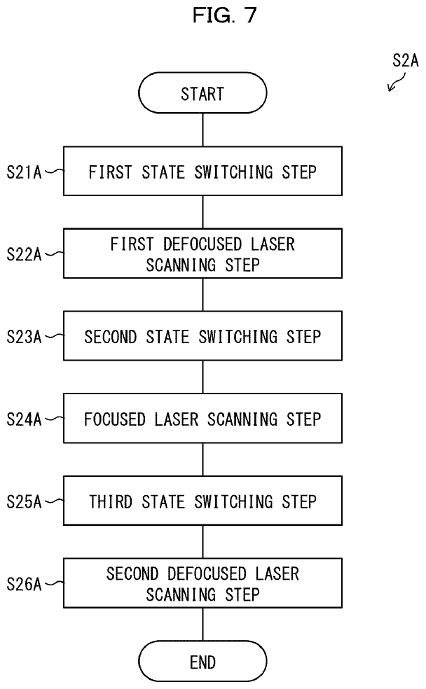

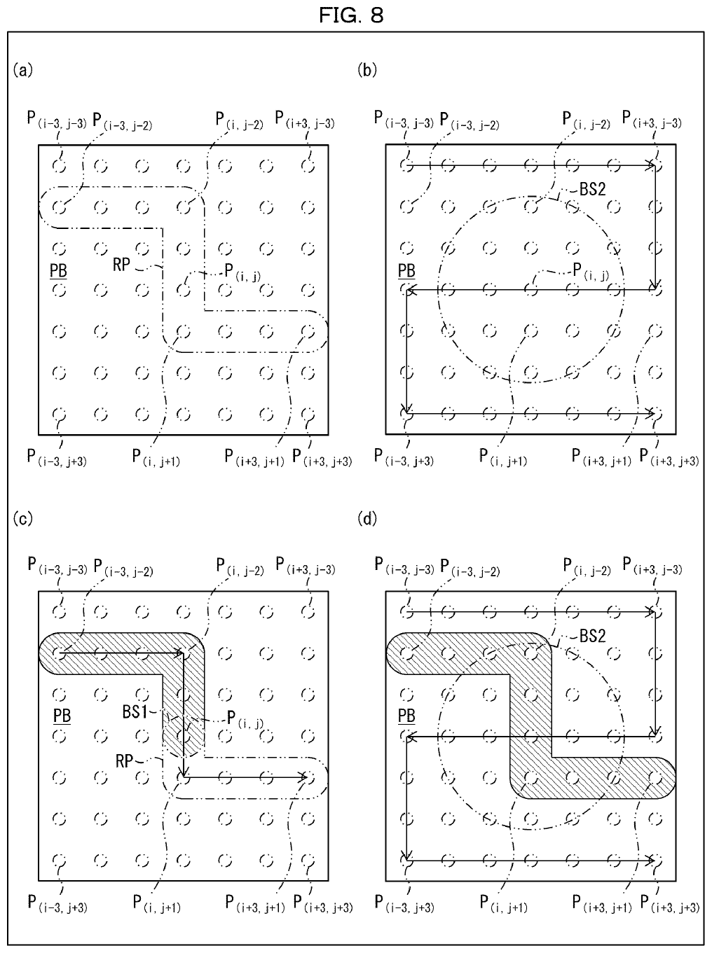

A laser light irradiation step S2A, which is a variation of the laser light irradiation step S2 described with reference to FIGS. 5 and 6, will be described with reference to FIGS. 7 and 8. FIG. 7 is a flowchart illustrating a flow of the laser light irradiation step S2A. (a) of FIG. 8 is a plan view illustrating a region RP which is irradiated with laser light in the laser light irradiation step S2A. (b) of FIG. 8 is a plan view showing that the inside of a certain region of a powder bed PB is scanned with laser light in a defocused state. (c) of FIG. 8 is a plan view showing that the inside of the region RP is scanned with laser light in a focused state. (d) of FIG. 8 is a plan view showing that the inside of a certain region of a powder bed PB is scanned with laser light in the defocused state. Note that the following description will discuss the laser light irradiation step S2A by using an example in which a metal shaped object MO is shaped by melting and solidifying a metal powder. However, it is possible to carry out the laser light irradiation step S2A so as to shape a metal shaped object MO by sintering a metal powder.

In the laser light irradiation step S2A, the control section 15 can control the irradiation device 13 to perform at least the following steps (1), (2), and (3) in this order: (1) a position, at which a surface of the powder bed PB is irradiated with laser light L, is moved (i.e. scanning is performed) while one of the focused state and the defocused state is maintained, (2) transition is made from the above one of the focused state and the defocused state to the other one, and (3) the position, at which the surface of the powder bed PB is irradiated with the laser light L, is moved (i.e. scanning is performed) while the other one of the focused state and the defocused state is maintained. According to the present embodiment, the control section 15 controls the irradiation device 13 to carry out the following steps (1), (2), and (3) in this order: (1) the surface of the powder bed PB is scanned with the laser light L while the focused state is maintained, (2) transition is made from the focused state to the defocused state, and (3) the surface of the powder bed PB is scanned with the laser light L while the defocused state is maintained.

With this configuration, it is possible to perform auxiliary heating before or after main heating. This makes it possible to cause residual stress in a metal shaped object MO to be further smaller.

In addition, in the laser light irradiation step S2A, the control section 15 preferably controls the irradiation device 13 to perform at least the following steps (1), (2), (3), (4), and (5) in this order: (1) the surface of the powder bed PB is scanned with laser light L while the defocused state is maintained, (2) transition is made from the defocused state to the focused state, (3) the surface of the powder bed PB is scanned with the laser light L while the focused state is maintained, (4) transition is made from the focused state to the defocused state, and (5) the position, at which the surface of the powder bed PB is irradiated with the laser light L, is moved while the defocused state is maintained.

With this configuration, it is possible to perform auxiliary heating before or after main heating. This makes it possible to cause residual stress in a metal shaped object to be even further smaller.

In comparison with the laser light irradiation step S2 described with reference to FIGS. 5 and 6, the laser light irradiation step S2A advantageously speeds up the shaping process. This is because, even if the intervals between scanning lines to be scanned with laser light L are set to be wide in each of the first defocused laser scanning step S22A and the second defocused laser scanning step S26A with which auxiliary heating is to be performed (described later), it is still possible to perform sufficient auxiliary heating due to a large beam spot diameter D2.

Such a laser light irradiation step S2A will be described below by using a concrete example.

When the control section 15 has obtained information concerning a region RP to be irradiated with laser light, the control section 15 determines a plurality of irradiation points to be irradiated with the laser light L in the region RP. (a) of FIG. 8 illustrates a region RP which is provided in at least part of the whole region of the powder bed PB and which has a crank shape.

In the square region illustrated in (a) of FIG. 8, the control section 15 determines a plurality of irradiation points P_{(i-3,j-3)} through P_{(i+3,j+3)} arranged in a matrix. Note that i is an integer of 1 to N, and N is any integer. Not also that j is an integer of 1 to M, and M is any integer. Out of the plurality of irradiation points P_{(i-3,j-3)} through P_{(i+3,j+3)} arranged in a matrix in each of (a) through (d) of FIG. 8, the following irradiation points are given reference signs: (i) irradiation points P_{(i-3,j-3)}, P_{(i+3,j-3)}, P_{(i-3,j+3)}, and P_{(i+3,j+3)} which are positioned at respective four corners of the square region, (ii) irradiation points P_{(i-3,j-2)} and P_{(i+3,j+1)} which are positioned at respective ends of the region RP having the crank shape, and (iii) irradiation points P_{(i,j-2)} and P_{(i,j+1)} which are positioned at respective bending points included in the region RP. Reference signs for any other irradiation points are omitted in order to avoid causing (a) through (d) of FIG. 8 to be complex and therefore difficult to see.

According to the present variation, the control section 15 determines the irradiation points P_{(i-3,j-2)} through P_{(i,j-2)}, the irradiation points P_{(i,j-1)} through P_{(i,j+1)}, and the irradiation points P_{(i+1,j+1)} through P_{(i+3,j+1)} as the plurality of irradiation points of the region RP.

According to the present embodiment, the control section 15 obtains the information concerning the region RP from an outside source. However, the region RP can be a region that is determined in advance. In addition, according to the present embodiment, the control section 15 determines the plurality of irradiation points included in the region RP. However, if the region RP is determined in advance, the positions of the plurality of irradiation points can also be determined in advance.

Intervals between adjacent irradiation points Pᵢ (e.g. a distance between centers of P_{(i,j)} and P_{(i+1,j)}) can be set as with the laser light irradiation step S2. The description thereof will therefore be omitted.

As illustrated in FIG. 7, the laser light irradiation step S2A includes a first state switching step S21A, a first defocused laser scanning step S22A, a second state switching step S23A, a focused laser scanning step S24A, a third state switching step S25A, and a second defocused laser scanning step S26A.

The first state switching step S21A is the step of switching the state of the irradiation device 13 from the focused state to the defocused state (in other words, the step of transitioning the state). In the first state switching step S21A, the control section 15 switches the state of the irradiation device 13 from the focused state to the defocused state. In a case where the irradiation device 13 is in the defocused state when the first state switching step S21A is to be carried out, the control section 15 causes the irradiation device 13 to remain in the defocused state without changing the state of the irradiation device 13.

As illustrated in (b) of FIG. 8, the first defocused laser scanning step S22A is the step of scanning the surface of the powder bed PB with laser light L while the defocused state is maintained. During the first defocused laser scanning step S22A, the control section 15 controls the irradiation device 13 so that the beam spot of the laser light L on the surface of the powder bed PB is a beam spot BS2. As described above, the beam spot diameter D2 (see (d) of FIG. 2) of the beam spot BS2 of the laser light L emitted from the irradiation device 13 in the defocused state is larger than the beam spot diameter D1 (see (c) of FIG. 2). Therefore, even if not all of the irradiation points P_{(i-3,j-3)} through P_{(i+3,j+3)} are irradiated with the laser light L, the square region illustrated in (b) of FIG. 8 can be irradiated in its entirety with the laser light L by widening the intervals between the scanning lines to be scanned with the laser light L (in FIG. 8, the scanning lines are (1) a first scanning line formed by a straight line connecting the irradiation point P_{(i-3,j-3)} and the irradiation point P_{(i+3,j-3)}, (2) a second scanning line formed by a straight line connecting the irradiation point P_{(i-3,j)} and the irradiation point P_{(i+3,j)}, and (3) a third scanning line formed by a straight line connecting the irradiation point P_{(i-3,j+3)} and the irradiation point P_{(i+3,j+3)}).

Note that in a case where a period of time required for the first defocused laser scanning step S22A is to be reduced as much as possible, one option is to set wide intervals between the scanning lines. However, if the intervals between the scanning lines are excessively wide, it is then not possible to irradiate the entire square region illustrated in (a) of FIG. 8 with laser light. That is, part of the whole region of the powder bed PB will not be subjected to auxiliary heating. In order to irradiate the entire square region illustrated in (a) of FIG. 8 with laser light, the intervals between the scanning lines are preferably not more than the beam spot diameter D2.

Note, however, that even if part of the whole region of the powder bed PB is not subjected to the auxiliary heating, a large portion of the powder bed PB is irradiated with the laser light L. Therefore, in comparison with the case where the first defocused laser scanning step S22A is omitted, residual stress in a metal shaped object MO can be made smaller.

The second state switching step S23A is the step of switching the state of the irradiation device 13 from the defocused state to the focused state (in other words, the step of transitioning the state). In the second state switching step S23A, the control section 15 switches the state of the irradiation device 13 from the defocused state to the focused state.

As illustrated in (c) of FIG. 8, the focused laser scanning step S24A is the step of scanning the surface of the powder bed PB with laser light L while the irradiation device 13 remains in the focused state. In the focused laser scanning step S24A, the control section 15 controls the irradiation device 13 to scan, with laser light L, the following plurality of irradiation points of the region RP in the order named: the irradiation points P_{(i-3,j-2)} through P_{(i,j-2)}, the irradiation points P_{(i,j-1)} through P_{(i,j+1)}, and the irradiation points P_{(i+1,j+1)} through P_{(i+3,j+1)}. (c) of FIG. 8 shows that the irradiation point P_{(i,j)} is being irradiated with the laser light L in the focused laser scanning step S24A. In a case where the focused laser scanning step S24A is carried out, a metal powder is melted and then solidified in the vicinity of each irradiation point irradiated with the laser light L (i.e. the irradiation point P_{(i,j)} in the example of (c) of FIG. 8).

The third state switching step S25A is the step of switching the state of the irradiation device 13 from the focused state to the defocused state (in other words, the step of transitioning the state). In the third state switching step S25A, the control section 15 switches the state of the irradiation device 13 from the focused state to the defocused state.

As illustrated in (d) of FIG. 8, the second defocused laser scanning step S26A is the step of, after the focused laser scanning step S24A, scanning the surface of the powder bed PB with laser light L while the defocused state is maintained. According to the present embodiment, the intervals between the scanning lines employed in the second defocused laser scanning step S26A are identical to the intervals between the scanning lines employed in the first defocused laser scanning step S22A. Specifically, according to the present embodiment, scanning with laser light is performed as follows: (1) the scanning is performed on the above-described first scanning line, from the irradiation point P_{(i-3,j-3)} toward the irradiation point P_{(i+3,j-3)}, (2) the scanning is performed from the irradiation point P_{(i+3,j-3)} toward the irradiation point P_{(i+3,j)}, (3) the scanning is performed on the above-described second scanning line, from the irradiation point P_{(i+3,j)} toward the irradiation point P_{(i-3,j)}, (4) the scanning is performed from the irradiation point P_{(i-3,j)} toward the irradiation point P_{(i-3,j+3)}, and (5) the scanning is performed on the above-described third scanning line, from the irradiation point P_{(i-3,j+3)} toward the irradiation point P_{(i+3,j+3)}. Note that the intervals between the scanning lines employed in the second defocused laser scanning step S26A can be identical to or different from the intervals between the scanning lines employed in the first defocused laser scanning step S22A.

The laser light irradiation step S2A can further include, before the second defocused laser scanning step S26A, the step of determining whether or not the second defocused laser scanning step S26A is to be omitted, depending on the temperature of the surface of the powder bed PB after the step focused laser scanning step S24A is carried out. The temperature of the surface of the powder bed PB can be measured with use of the measuring section 14 described above. In such a step, (1) if the temperature of the surface of the powder bed PB after the focused laser scanning step S24A is not less than a predetermined temperature, it is determined that the second defocused laser scanning step S26A will be omitted and (2) if the temperature of the surface of the powder bed PB after the focused laser scanning step S24A is lower than the predetermined temperature, it is determined that the second defocused laser scanning step S26A will not be omitted. This is because in the case (1), residual stress in a metal shaped object MO is considered to fall within a tolerable range even if the second defocused laser scanning step S26A is omitted. Note that although not particularly illustrated, the metal shaping device or the metal shaping system can include a determining section configured to determine whether or not the second defocused laser scanning step S26A is to be omitted. Alternatively, such a determining process can be carried out by the control section 15.

Assume a case where, after the focused laser scanning step S24A is carried out with respect to the described-above region RP (hereinafter referred to as “first region RP1”), a second region RP2, which is a region other than the first region RP1 and which is included in the square region illustrated in (a) of FIG. 8, is to be irradiated with the laser light L. For such a case, the laser light irradiation step S2A can be set so that the focused laser scanning step S24A is carried out with respect to the second region RP2 while omitting the second defocused laser scanning step S26A with respect to the first region RP1 and the first defocused laser scanning step S22A with respect to the second region RP2. This is because at a time point at which the focused laser scanning step S24A with respect to the first region RP1 is completed, the surface temperature within the square region illustrated in (a) of FIG. 8 has presumably been raised to a predetermined temperature or higher, due to laser light with which the first region RP1 was irradiated in the first defocused laser scanning step S22A and in the focused laser scanning step S24A. Note that in a case where the laser light irradiation step S2A includes the step of measuring the surface temperature of the square region of (a) of FIG. 8 at the time point at which the focused laser scanning step S24A with respect to the first region RP1 is completed, it is possible to further accurately determine whether or not the second defocused laser scanning step S26A with respect to the first region RP1 and the first defocused laser scanning step S22A with respect to the second region RP2 is to be omitted. Note that although not particularly illustrated, the metal shaping device or the metal shaping system can include a determining section configured to determine whether or not the second defocused laser scanning step S26A with respect to the first region RP1 and the first defocused laser scanning step S22A with respect to the second region RP2 is to be omitted. Alternatively, such a determining process can be carried out by the control section 15.

Note that the laser light irradiation step S2A in accordance with the present embodiment includes the first defocused laser scanning step S22A, the focused laser scanning step S24A, and the second defocused laser scanning step S26A. However, the laser light irradiation step S2A can exclude one of the first defocused laser scanning step S22A and the second defocused laser scanning step S26A.

(Recap)

An irradiation device (13, 13A) in accordance with an aspect of the present invention is an irradiation device (13, 13A) for use in metal shaping, including: an irradiating section (13a, 13Aa) configured to irradiate, with laser light (L), a powder bed (PB) containing a metal powder, the irradiating section (13a, 13Aa) being able to be switched between (i) a focused state in which a beam spot diameter (D1) of the laser light (L) on a surface of the powder bed (PB) has a first value and (ii) a defocused state in which the beam spot diameter (D2) of the laser light (L) on the surface of the powder bed (PB) has a second value which is larger than the first value.

The irradiation device (13, 13A) in accordance with an aspect of the present invention is preferably configured so that: when the irradiating section (13a, 13Aa) is in the focused state, a temperature of a region of the surface of the powder bed (PB), which region is irradiated with the laser light (L), is not less than a melting point (Tm) of the metal powder; and when the irradiating section (13a, 13Aa) is in the defocused state, the temperature of the region of the surface of the powder bed, which region is irradiated with the laser light, is 0.5 times to 0.8 times as high as the melting point (Tm) of the metal powder.

The irradiation device (13, 13A) in accordance with an aspect of the present invention is preferably configured so that the irradiating section (13a, 13Aa) is configured to be transitioned from the focused state to the defocused state or transitioned from the defocused state to the focused state, while a position of an irradiation point irradiated with the laser light (L) on the surface of the powder bed (PB) is maintained.

The irradiation device (13, 13A) in accordance with an aspect of the present invention can be configured so that the irradiating section (13a, 13Aa) is configured to be transitioned from the defocused state to the focused state and then transitioned from the focused state to the defocused state, while the position of the irradiation point irradiated with the laser light (L) on the surface of the powder bed (PB) is maintained.

The irradiation device (13, 13A) in accordance with an aspect of the present invention is preferably configured so that the irradiating section (13a, 13Aa) is configured to carry out at least the following steps (A) and (B) in this order: (A) a step in which a position irradiated with the laser light (L) on the surface of the powder bed (PB) is moved while one of the focused state and the defocused state is maintained; and (B) a step in which the position irradiated with the laser light (L) on the surface of the powder bed (PB) is moved while the other one of the focused state and the defocused state is maintained.

The irradiation device (13, 13A) in accordance with an aspect of the present invention can be configured so that the irradiating section (13a, 13Aa) is configured to carry out at least the following steps (A), (B), and (C) in this order: (A) a step in which the position irradiated with the laser light (L) on the surface of the powder bed (PB) is moved while the defocused state is maintained, (B) a step in which the position irradiated with the laser light (L) on the surface of the powder bed (PB) is moved while the focused state is maintained, and (C) a position in which the position irradiated with the laser light (L) on the surface of the powder bed (PB) is moved while the defocused state is maintained.

The irradiation device (13, 13A) in accordance with an aspect of the present invention is preferably configured to further include: a first condensing lens (13b) which is configured to be inserted into an optical path of the laser light (L) and which is configured so that a position of the first condensing lens is moved so as to switch between the focused state and the defocused state.

The irradiation device (13, 13A) in accordance with an aspect of the present invention is preferably configured to further include: a second condensing lens (13Aa3) which is provided at a position different from the position of the first condensing lens (13b) and which is configured to be inserted into and removed from the optical path so as to switch between the focused state and the defocused state.

An irradiating section (13a, 13Aa) in accordance with an aspect of the present invention is configured to irradiate, with laser light (L), a powder bed (PB) containing a metal powder, the irradiating section being able to be switched between (i) a focused state in which a beam spot diameter (D1) of the laser light (L) on a surface of the powder bed (PB) has a first value and (ii) a defocused state in which the beam spot diameter (D2) of the laser light (L) on the surface of the powder bed (PB) has a second value which is larger than the first value.

A metal shaping device in accordance with an aspect of the present invention is a metal shaping device including: any one of the irradiation devices (13, 13A) described above; and an optical fiber (12) through which the laser light (L) is to be guided.

The metal shaping device in accordance with an aspect of the present invention is preferably configured to further include: a control section (15) configured to control the irradiating section (13a, 13Aa) so that when the irradiating section (13a, 13Aa) is in the defocused state, the temperature of the region of the surface of the powder bed (PB), which region is irradiated with the laser light (L), is 0.5 times to 0.8 times as high as the melting point (Tm) of the metal powder.

A metal shaping device in accordance with an aspect of the present invention preferably includes: the irradiation device (13, 13A) in accordance with any one of the aspects of the present invention described above; an optical fiber (12) through which the laser light (L) is to be guided; and a control section (15) configured to control the position of the first condensing lens (13b) so as to switch between the focused state and the defocused state.

A metal shaping device in accordance with an aspect of the present invention preferably includes: the irradiation device (13, 13A) in accordance with any one of the aspects of the present invention described above; an optical fiber (12) through which the laser light (L) is to be guided; and a control section (15) configured to control whether the second condensing lens (13Aa3) is inserted into or removed from the optical path, so as to switch between the focused state and the defocused state.

A metal shaping system (1) in accordance with an aspect of the present invention includes: a metal shaping device in accordance with an aspect of the present invention; a laser device (11) configured to output the laser light (L); and a shaping table (10) configured to hold the powder bed (PB).

An irradiation method in accordance with an aspect of the present invention includes the steps of: irradiating, with laser light (L), a powder bed (PB) containing a metal powder, in the irradiating, switching being made between (i) a focused state in which a beam spot diameter (D1) of the laser light (L) on a surface of the powder bed (PB) has a first value and (ii) a defocused state in which the beam spot diameter (D2) of the laser light (L) on the surface of the powder bed (PB) has a second value which is larger than the first value.

A metal shaped object production method in accordance with an aspect of the present invention is a method of producing a metal shaped object (MO), including the steps of: irradiating, with laser light (L), a powder bed (PB) containing a metal powder, in the irradiating, switching being made between (i) a focused state in which a beam spot diameter (D1) of the laser light (L) on a surface of the powder bed (PB) has a first value and (ii) a defocused state in which the beam spot diameter (D2) of the laser light (L) on the surface of the powder bed (PB) has a second value which is larger than the first value.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1 Metal shaping system
10 Shaping table
10a Recoater
10b Roller
10c Stage
10d Table main body
11 Laser device (fiber laser)
12 Optical fiber
13 Irradiation device
13a Galvano scanner (irradiating section)
13a1 First galvano mirror
13a2 Second galvano mirror
13b Condensing lens (first condensing lens)
13A Irradiation device (variation)
13Aa Galvano scanner (irradiating section) (variation)
13Aa3 Condensing lens (second condensing lens)
14 Measuring section
15 Control section
L Laser light
RP1 First region
RP2 Second region
BS1, BS2 Beam spot
D1 Beam spot diameter (focused state)
D2 Beam spot diameter (defocused state)
Tm Melting point
PB Powder bed
MO Metal shaped object

1. An irradiation device for use in metal shaping, comprising:
an irradiating section configured to irradiate, with laser light, a powder bed containing a metal powder,
the irradiating section being able to be switched between (i) a focused state in which a beam spot diameter of the laser light on a surface of the powder bed has a first value and (ii) a defocused state in which the beam spot diameter of the laser light on the surface of the powder bed has a second value which is larger than the first value.

2. The irradiation device according to claim 1, wherein:
when the irradiating section is in the focused state, a temperature of a region of the surface of the powder bed, which region is irradiated with the laser light, is not less than a melting point of the metal powder; and
when the irradiating section is in the defocused state, the temperature of the region of the surface of the powder bed, which region is irradiated with the laser light, is 0.5 times to 0.8 times as high as the melting point of the metal powder.

3. The irradiation device according to claim 1, wherein
the irradiating section is configured to be transitioned from the focused state to the defocused state or transitioned from the defocused state to the focused state, while a position of an irradiation point irradiated with the laser light on the surface of the powder bed is maintained.

4. The irradiation device according to claim 3, wherein
the irradiating section is configured to be transitioned from the defocused state to the focused state and then transitioned from the focused state to the defocused state, while the position of the irradiation point irradiated with the laser light on the surface of the powder bed is maintained.

5. The irradiation device according to claim 1, wherein
the irradiating section is configured to carry out at least the following steps (1) and (2) in this order: (1) a step in which a position irradiated with the laser light on the surface of the powder bed is moved while one of the focused state and the defocused state is maintained; and (2) a step in which the position irradiated with the laser light on the surface of the powder bed is moved while the other one of the focused state and the defocused state is maintained.

6. The irradiation device according to claim 5, wherein
the irradiating section is configured to carry out at least the following steps (1), (2), and (3) in this order: (1) a step in which the position irradiated with the laser light on the surface of the powder bed is moved while the defocused state is maintained, (2) a step in which the position irradiated with the laser light on the surface of the powder bed is moved while the focused state is maintained, and (3) a step in which the position irradiated with the laser light on the surface of the powder bed is moved while the defocused state is maintained.

7. The irradiation device according to claim 1, further comprising:
a first condensing lens which is configured to be inserted into an optical path of the laser light and which is configured so that a position of the first condensing lens is moved so as to switch between the focused state and the defocused state.

8. The irradiation device according to claim 7, further comprising:
a second condensing lens which is provided at a position different from the position of the first condensing lens and which is configured to be inserted into and removed from the optical path so as to switch between the focused state and the defocused state.

9. An irradiation section configured to irradiate, with laser light, a powder bed containing a metal powder,
the irradiating section being able to be switched between (i) a focused state in which a beam spot diameter of the laser light on a surface of the powder bed has a first value and (ii) a defocused state in which the beam spot diameter of the laser light on the surface of the powder bed has a second value which is larger than the first value.

10. A metal shaping device comprising:
the irradiation device according to claim 1; and
an optical fiber through which the laser light is to be guided.

11. The metal shaping device according to claim 10, further comprising:
a control section configured to control the irradiating section so that when the irradiating section is in the defocused state, the temperature of the region of the surface of the powder bed, which region is irradiated with the laser light, is 0.5 times to 0.8 times as high as the melting point of the metal powder.

12. A metal shaping device comprising:
the irradiation device according to claim 7;
an optical fiber through which the laser light is to be guided; and
a control section configured to control the position of the first condensing lens so as to switch between the focused state and the defocused state.

13. A metal shaping device comprising:
the irradiation device according to claim 8;
an optical fiber through which the laser light is to be guided; and
a control section configured to control whether the second condensing lens is inserted into or removed from the optical path, so as to switch between the focused state and the defocused state.

14. A metal shaping system comprising:
the metal shaping device according claim 10;
a laser device configured to output the laser light; and
a shaping table configured to hold the powder bed.

15. An irradiation method comprising the steps of:
irradiating, with laser light, a powder bed containing a metal powder,
in the irradiating, switching being made between (i) a focused state in which a beam spot diameter of the laser light on a surface of the powder bed has a first value and (ii) a defocused state in which the beam spot diameter of the laser light on the surface of the powder bed has a second value which is larger than the first value.

16. (canceled)
